(19) United States
(12) Patent Application Publication
(10) Pub. No.: US 2015/0195644 A1
(43) Pub. Date: Jul. 9, 2015

(54) STRUCTURAL ELEMENT FOR SOUND FIELD ESTIMATION AND PRODUCTION

(71) Applicant: Microsoft Corporation, Redmond, WA (US)

(72) Inventors: Andrew D. Wilson, Seattle, WA (US); Daniel Morris, Bellevue, WA (US); Desney S. Tan, Kirkland (SG); Yong Rui, Beijing (CN); Nikunj Raghuvanshi, Redmond, WA (US); Jeannette M. Wing, Bellevue, WA (US)

(73) Assignee: Microsoft Corporation, Redmond, WA (US)

(21) Appl. No.: 14/151,763

(22) Filed: Jan. 9, 2014

(51) Int. Cl. H04R 1/40; H04R 1/08

(52) U.S. Cl. CPC H04R 1/40; H04R 1/08; H04R 2201/40

(57) ABSTRACT

A structural or aesthetic construction element, such as a wall section, is described herein, wherein the construction element has embedded therein an array of microphones, an array of speakers, and processing electronics that drives the array of microphones and the array of speakers. Audio captured by the microphones can be used to estimate a sound field corresponding to the construction element. Speakers in the array of speakers are configured to directionally output audio, such that a desired sound field is produced or reproduced.

### BACKGROUND

Beyond maintaining privacy, acoustic properties of indoor environments are rarely considered in the design of buildings. More sophisticated audio design is considered in the context of theaters, large professional performance spaces, and the like, but these examples are typically designed with a single goal (e.g., make a performance space more or less “live”), and are not programmable. For example, foam tiles in the ceiling of a room perform only a single, limited function of deadening the sound in the room.

### SUMMARY

The following is a brief summary of subject matter that is described in greater detail herein. This summary is not intended to be limiting as to the scope of the claims.

Described herein are various technologies pertaining to configuring a structural and/or aesthetic element of a building to capture a sound field of a volume in a region of the building proximate to the structural and/or aesthetic element. Also described herein are various technologies pertaining to configuring a structural and/or aesthetic element of a building to reproduce a sound field of a volume of a region (e.g., in real-time or delayed). An exemplary structural element is a wall section that is formed to include a speaker array, wherein the speaker array comprises a plurality of speakers. The speakers can be driven, for example, to output audio streams that collectively reproduce a sound field of a volume of region. The exemplary wall section can also be formed to include a microphone array that comprises a plurality of microphones, where audio signals output by the plurality of microphones can be representative of a sound field of a volume proximate to the wall section. Other structural elements that can be configured in the manner described above are also contemplated, including but not limited to a door, a ceiling or ceiling section, a support beam, and the like. Exemplary aesthetic elements include baseboard, crown molding, door or window trim, chair rail, bead board, or the like, wherein such aesthetic elements can be manufactured to include a speaker array and/or a microphone array. Still further, furniture/cabinetry can be formed to include a speaker array and/or a microphone array.

With respect to the structural feature being a wall section, the wall section can serve functions in addition to or as an alternative to a sound deadening mechanism, while maintaining its (potential) functions of being load-bearing as well as divider of space (e.g., a room or hall boundary). The wall section can include embedded electronics (in addition to physical construction functions) to record and produce audio in manners that shape the acoustics of the room with a boundary formed by the wall. For example, through utilization of the array of microphones, audio can be captured across a surface of the wall section, and such audio can be used to estimate a sound field of a volume proximate to the wall section (e.g., a sound field of a room at least partially bounded by the wall section). Additionally, through utilization of the array of speakers, audio can be emitted across the surface of the wall section, thus reproducing a sound field. A sound field can be produced at the wall section, for example, to alter the perspective of a listener of space in the room. For example, the sound field can be emitted to cause the listener to perceive, aurally, that the room is larger than its actual size. In another example, a first wall section of this type that at least partially forms a boundary of a first room at a first location can be configured to capture audio that can be employed to estimate a sound field proximate to the wall section, and a second wall section of this type that forms a boundary of a second room at a second location (remotely located from the first location) can emit audio in the second room that reproduces the sound field in near real-time. Thus, the sound field of the first room can be reproduced in the second room so that, aurally, the two rooms seem to share the same physical space (or are adjacent). In effect, such technology can provide a listener with a sensation of hearing through a wall.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 illustrates an exemplary structural construction element having embedded therein an array of microphones, an array of speakers, and corresponding processing electronics.

FIG. 2 illustrates an exemplary pair of remotely located structural construction elements that are configured to capture and reproduce sound fields, respectively.

FIG. 3 is an exemplary computing device that can receive signals output by respective microphones in a microwave array, estimate a sound field based upon the signals, and output audio signals for output at a speaker array.

FIG. 4 is a flow diagram illustrating an exemplary methodology for forming a structural or aesthetic construction element, such that the element comprises an array of speakers, an array of microphones, and corresponding audio processing circuitry.

FIG. 5 is a flow diagram illustrating an exemplary methodology for capturing and reproducing a sound field.

FIG. 6 is an exemplary computing system.

### DETAILED DESCRIPTION

Various technologies pertaining to structural and aesthetic construction elements formed to include electronics that can be used to estimate and reproduce sound fields are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by a single component may be performed by multiple components. Similarly, for instance, a single component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices. Further, as used herein, the term “exemplary” is intended to mean serving as an illustration or example of something, and is not intended to indicate a preference.

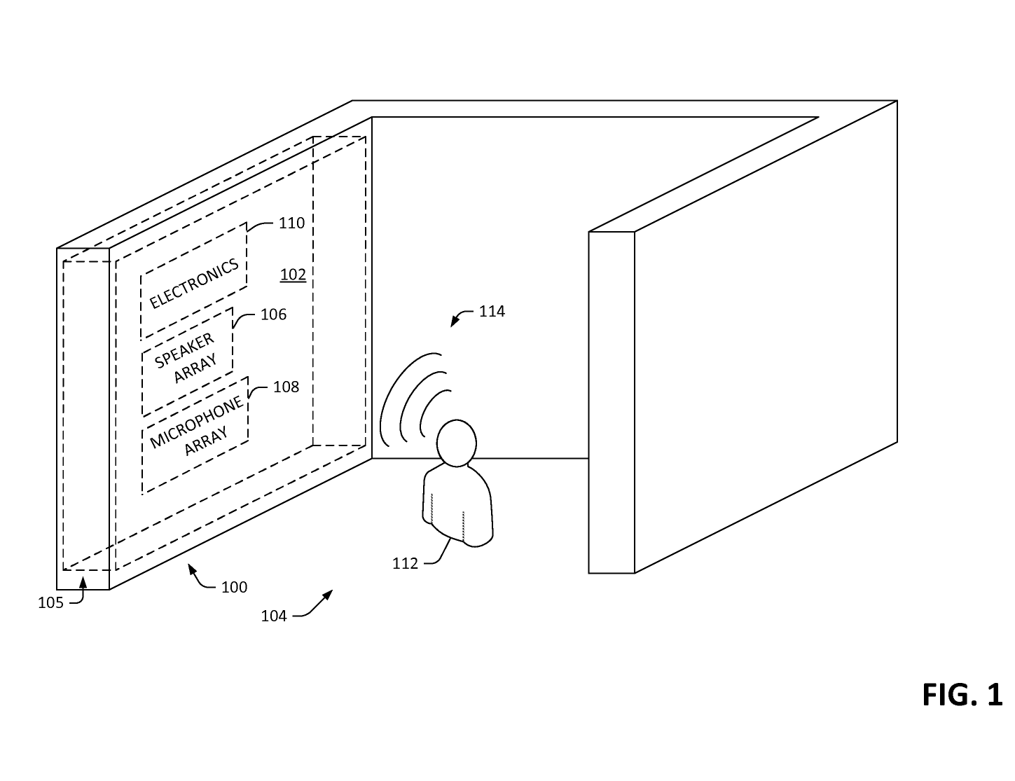

With reference now to FIG. 1, an exemplary structural or aesthetic construction element 100 that can be configured to capture audio signals and/or emit audio signals is illustrated. The exemplary construction element is shown in FIG. 1 as being a wall section, which acts as at least a portion of a boundary of a room 104. While the wall section is depicted as being an entirety of a wall, it is to be understood that the wall section may form a portion of the wall. The wall section serves the function of forming a boundary for the room 104, and can optionally be load-bearing in a building. Thus, the wall section is a relatively permanent structural divider between the room 104 and other space in a building (e.g., another room, a hallway, etc.) or an exterior of the building.

The wall section comprises a frame 105 that defines structural boundaries of the wall section. Additionally, while not shown, the wall section can comprise support studs (vertical or horizontal). The frame 105 (and optionally the support studs) can be formed of any suitable material, including wood, a plastic composite, a metal (e.g., aluminum, steel, a metal composite), or the like. The wall section further comprises a surface 102 that is affixed to the frame 105. The surface 102 can be affixed to the frame 105 by way of fastening mechanisms, such as (but not limited to) screws, nails, bolts, or the like. Further, the surface 102 can be affixed to the frame 105 by way of an epoxy. The surface 102 can be relatively thin (e.g., between one millimeter and five millimeters), can be composed of a material that facilitates transmission of audio therethrough. In an exemplary embodiment, the surface 102 can be a perforated surface. Further, the surface 102 can be formed of a material that facilitates receipt of a relatively thin layer of paint.

The surface 102, when affixed to the frame 105, forms an interior region of the wall section (which may also be referred to as a cavity). As shown in FIG. 1, a speaker array 106 that comprises a plurality of speakers can be positioned in the cavity formed by the surface 102 and the frame 105. For instance, a number of speakers in the wall section can be at least three speakers. In an exemplary embodiment, speakers can be arranged in matrix form. While the speaker array 106 is illustrated as being associated with a relatively small portion of the surface 102 of the wall section, it is to be understood that speakers in the speaker array 106 can be positioned in the cavity such that the speakers are distributed over nearly all of the surface 102 of the wall section.

Similarly, a microphone array 108 can be positioned in the cavity of the wall section, wherein the microphone array 108 can include a plurality of microphones. In an example, a number of microphones in the wall section can be at least three microphones. The array of microphones 108 can be arranged in matrix form. The cavity formed by the frame 105 and the surface 102 can also include audio processing electronics 110 that are electrically coupled to the speaker array 106 and the microphone array 108. The processing electronics 110 can be or include a central processing unit (CPU), a field-programmable gate array (FPGA), an application-specific integrated circuit (ASIC), or other suitable processing circuitry.

The processing electronics 110 are configured to drive (e.g., provide power to) the speaker array 106 and the microphone array 108. Further, the processing electronics 110 are configured to receive audio signals output by respective microphones in the microphone array 108 and transmit signals to respective speakers in the speaker array 106. Speakers in the speaker array 106 output audio responsive to receive of the signals from the processing electronics 110. In an exemplary embodiment, speakers in the speaker array 106 can be beamforming speakers, wherein the speakers in the speaker array 106 can be configured to operate in conjunction to directionally emit audio beams.

Aesthetics of the wall section can be similar to conventional wall sections (e.g., drywall sheets); that is, when one is viewing the surface 102 of the wall section from inside the room 104, the speaker array 106, the microphone array 108, and the processing electronics 110 are not visually discernible, as such elements are positioned in the cavity formed by the frame 105 and the surface 102. For example, when the wall section is planar, the speaker array 106 and the microphone array 108 can be arranged in a planar fashion flush with an interior surface of the surface 102, and potentially adhered to the interior surface of the surface 102. In another example, the frame 105 may be drywall with a cavity therein or an aperture therethrough, and the speaker array 106 and/or the microphone array 108 can be adhered to the drywall. In still yet another example, the surface 102 of the wall section can be curved, and microphones and speakers can be positioned flush with the surface 102.

In the exemplary embodiment where speakers in the spear array 106 and microphones in the microphone array 108 are arranged in a curved fashion, the speakers, the microphones, and/or the processing electronics 110 can be configured with data that is indicative of three-dimensional position of microphones and/or speakers relative to one another. Similarly, in the exemplary embodiment where speakers in the speaker array 106 and microphones in the microphone array 108 are arranged in a planar fashion, the speakers, the microphones, and/or the processing electronics 110 can be configured with data that is indicative of two-dimensional position of microphones and/or speakers relative to one another. This positional information can be employed by the processing electronics 110 in connection with processing signals that represent audio detected by the microphones and/or processing signals that represent audio to be emitted by the speakers.

The surface 102 can thus be a relatively thin, smooth, protective layer and can be laid over the speaker array 106, the microphone array 108, and/or the processing electronics 110, wherein the surface 102 can be formed of a material that provides minimal interference to acoustic frequencies output by the speakers in the speaker array 106, and minimal interference to acoustic frequencies detectable by microphones in the microphone array 108. Thereafter, paint can be applied over the protective layer—thus, the wall section (which may be nearly entirely covered with speakers and microphones) appears as a conventional wall section. Further, the wall section can be formed as a modular sheet, similar to how drywall is conventionally formed. In such an embodiment, at least one side of the wall section can have exposed electric connectors (e.g., male and/or female connectors), wherein another wall section can be electrically coupled to the wall section by way of the electric connectors (e.g., the another wall section has corresponding electric connectors). The speakers in the speaker array 106, the microphones in the microphone array 108, and the processing electronics 110 can be powered by a hidden power source, such as an AC socket internal to the wall 102.

While the wall section has been set forth as an exemplary form factor for including an array of microphones, an array of speakers, and corresponding processing electronics, it is to be understood that other structural or aesthetic building materials can be configured to have a speaker array, a microphone array, and (optionally) processing electronics embedded therein. For instance, other exemplary form factors that can exist in the room 104 and that can have embedded therein the audio electronics described as being embedded in the wall section can include baseboards, chair rail, crown molding, a door, a door frame, a window frame, a ceiling, a column, a beam, a stairway element (e.g., a step, a banister, a railing), fireplace elements (e.g., a mantle, a support beam), etc. Further, furniture and cabinetry can be configured to have embedded therein a speaker array, a microphone array, and/or processing electronics. Generally, such building materials can be prefabricated to include the audio equipment described herein, such that the acts of constructing a wall, affixing crown molding to a wall or ceiling, etc. remains unchanged. In other embodiments, a building material that comprises the speaker array 106, the microphone array 108, and processing electronics 110 can be manufactured and sold as an aftermarket product, which can be affixed to an existing wall through utilization of adhesive, in a manner similar to rolling wallpaper onto a wall (e.g., due to the continuing reduction in thickness of speakers and microphones).

Again referring to the exemplary form factor of a wall section, advantages corresponding to such form factor are presented. First, a relatively large wall section surface can allow for the embedding of a relatively large number of speakers and microphones therein. Additionally, the relatively large form factor of the wall section can permit a relatively wide distribution of speakers and microphones, which, as will be described below, can facilitate relatively accurate estimation and reproduction of a sound field. A sound field is a point-wise difference of air pressure and a mean atmospheric pressure, expressed as a function of time, throughout a given volume of space. Still further, one can conceive that the wall section is a “shared” space between two remote physical spaces, and inhabitants of the room 104 can exploit intuition about how acoustics and architectural spaces function together if they are told that it is as if there is no wall between the two remote physical spaces.

Exemplary applications that include use of the wall section are now set forth. A person 112 can be located in the room 104, and as shown, can cause sound (acoustic vibrations) 114 to be generated. Such sound 114 can be generated by voice of the person 112, by movement of the person 112 about the room 104, etc. Further, other ambient noise sources can cause other sounds to be generated in the room 104 over time. Microphones in the microphone array 108 can be powered by the processing electronics 110, and can be configured to output audio signals that are representative of respective sounds captured at respective microphones in the microphone array 108. The processing electronics 110 receives the audio signals output by the microphones, and, for example, can estimate a sound field in a volume that is proximate to the wall section (e.g., a sound field of the room 104) based upon the signals from the microphones and positions of the respective microphones relative to one another. As noted above, the term “sound field” refers to a point-wise difference of air pressure and mean atmospheric pressure, expressed as a function of time, throughout a given volume of space (e.g., the room 104). For example, the room 104 forms a volume of space; for each point in the volume of space, a difference between pressure and mean atmospheric pressure can be observed over time, where the mean atmospheric pressure is a fixed quantity (at a given temperature and humidity). In an exemplary embodiment, the processing electronics 110 can extract feature sets from respective audio signals output by microphones in the microphone array 108, and can estimate the sound field based upon the extracted feature sets. In another exemplary embodiment, as will be described in greater detail below, the processing electronics 110 can extract the feature sets from the respective audio signals and transmit such feature sets to a remotely situated computing device by way of a network connection (e.g., the Internet). The remotely situated computing device (e.g., a “cloud”-based computing device) can receive the feature sets and estimate the sound field of the room 104. As can be ascertained, resolution of an estimated sound field is a function of spatial distribution and number of microphones in the wall section.

Speakers in the speaker array 106 can be driven by the processing electronics 110 to produce a sound field. It can be ascertained that the resolution of the sound field produced (or reproduced) by the speakers in the speaker array 106 can be a function of a number of speakers in the speaker array 106 and their distribution throughout the wall section. Further, as noted above, the speaker array 106 may include beamforming speakers, which can directionally emit audio beams. Accordingly, the speaker array 106, in an example, need not produce an entirety of a sound field for a relatively large volume, but rather can produce the sound field for the volume that encompasses the ears of the person 112 (e.g., where the location of the person 112 can be determined based upon signals output by the microphone array 106).

Given that the componentry of the wall section can be configured to both estimate and produce a sound field, various applications are enabled. In an exemplary embodiment, the wall section can be configured to perform selective noise cancellation in the room 104. For example, the sound field estimated for the volume encompassing the ears of the person 112 can include audio beams at particular locations travelling in certain respective directions, where the audio beams have particular respective frequencies (e.g., potentially having respective phases). The processing electronics 110 can be configured to drive the speakers in the speaker array 106 to attenuate energy at certain frequencies while amplifying energy at other frequencies. For instance, the processing electronics 110 can transmit signals to speakers in the speaker array 106 that can attenuate or amplify speech of the person 112 as heard by others in the room 104. The wall section (e.g., the speakers therein) can also be used to modify acoustic properties of the room. For example, the processing electronics 110 can transmit signals to respective speakers in the wall section to make a small room “sound” like a larger room to the person 112 by enhancing reverberation. In another example, the processing electronics 110 can transmit signals to respective speakers in the wall section to make the room 104 feel smaller to the person 112 by cancelling audio in real-time. Attenuation or amplification can be used to create a sound field that gives the impression that the wall is not present (e.g., the person 112 perceives that open space exists at the wall 102). In other words, visual privacy is preserved but audio privacy is not.

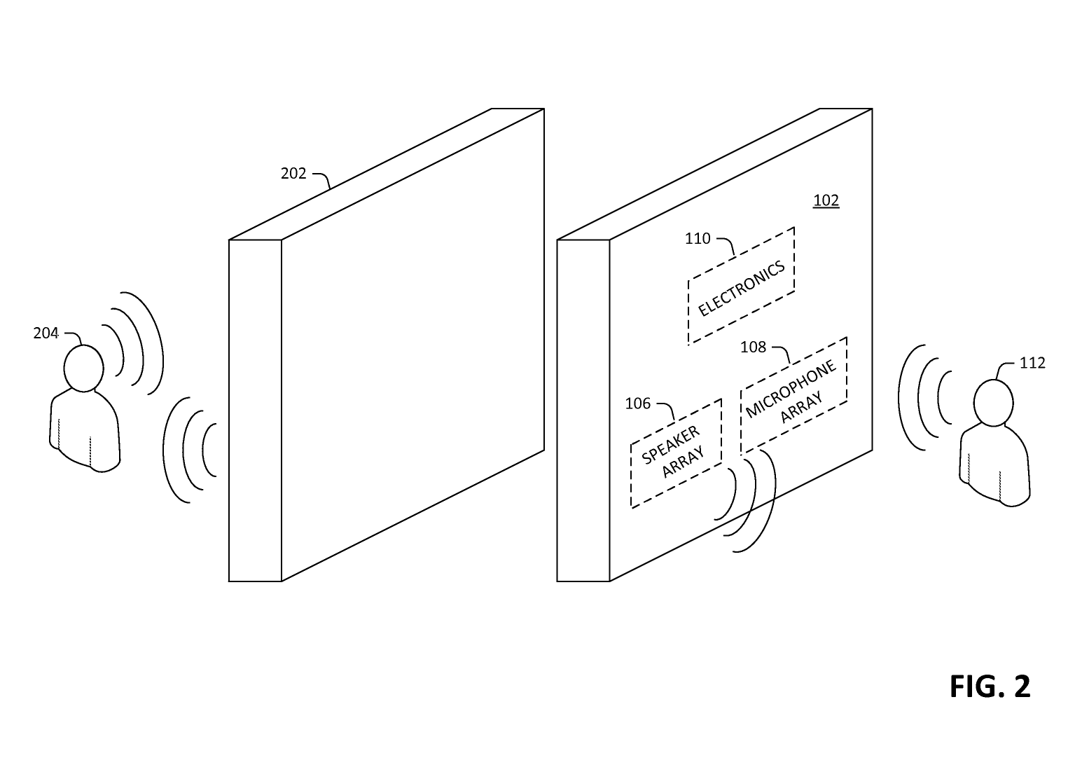

Turning to FIG. 2, utilization of the wall section in an audio telepresence application is illustrated. The person 112 is positioned in the room 104, wherein the wall section forms at least a portion of a structural boundary of the room 104. A second wall section 202 that includes a speaker array, a microphone array, and processing electronics (not shown) forms at least a portion of a structural boundary of another room, and a second person 204 is in such room. In an example, the second wall section 202 can be configured to replicate the sound field that is estimated based upon audio signals output by microphones in the microphone array 108. This can cause the person 112 and the second person 204 to have the perception that the two rooms are connected, without intrusiveness or distraction of a video link. Further, with respect to people familiar with one another, such people often engage in significant conversation while doing their own activities, and without looking at one another. Further, the audio telepresence can be performed in combination with energy attenuation and amplification, such that certain kinds of sounds in one room can be amplified or attenuated when presented in the other room. For instance, the person 112 may be a child and the second person 204 can be a parent. A sound of the child crying can be amplified by speakers of the second wall section 202, thereby gaining the attention of the parent.

It can further be noted that the speaker array 106 and the microphone array 108 can be used to provide sensed and replicated audio that replicates the direction and quality (e.g., reverberation) of the original sound source, such that the person 112 and the second person 204 feel as if they are physically adjacent. This can leverage the familiarity of the person 112 and the second person 204 with the environment where they are undertaking activities. Further, the wall section can manipulate audio spatially in other manners, such as to cause less important content to sound to a person as if it is being generated from a relatively far away sound source.

Returning to FIG. 1, the wall section can be used in combination with other sensing systems. Exemplary sensing systems that can be used with the wall section include, but are not limited to, mobile computing devices (e.g., mobile phones, slate computing devices, phablet computing devices, wearables, . . . ), implanted devices (e.g., hearing aids), or the like. For instance, a microphone in a mobile computing device can capture audio at a particular position relative to the wall section, and the mobile computing device can transmit a signal to the processing electronics 110 that is representative of the captured audio (and optionally the position of the mobile computing device relative to the wall section). The processing electronics 110 can estimate the sound field based upon the received signal and/or can drive speakers in the speaker array based on the received signal. Further, the processing electronics 110 can transmit a signal to the mobile computing device that causes the mobile computing device to generate an output, such as an audio signal, display data, or the like.

In yet another example, a sensing system, such as a computer vision system, can be used to filter audio. In an exemplary embodiment, operation of microphones and speakers driven by the processing electronics 110 can change in response to the computer vision system detecting a local or remote event. For example, the computer vision system can be used to determine which audio events are appropriate to transmit, such as when an elderly person is having trouble completing a task. Further, it may be desirable to create a sense of co-presence while preserving the privacy of the person 112. In this case, the wall section 202 can modify or “fuzz” the speech of the person 112, such that an individual receiving audio can discern that the person is speaking, but the speech cannot be understood. Similarly, the speech of the person 112 can be translated from a first language to a second language, and translated speech can be provided to another listener (e.g., with directionality and amplitude corresponding the speech of the person 112 as captured by microphones in the microphone array 106).

Still further, the processing electronics 110 (or a remotely situated computing device) can be associated with data storage, and can record an estimated sound field over a period of time. Subsequently, the processing electronics can cause speakers in the speaker array 106 to reproduce the sound field. In another example, a sound field corresponding to another location can be estimated, recorded, and played back by speakers of the wall section. For instance, the sound field may be from a desirable location (e.g., a recent beach vacation) or of a particularly memorable event. Further, the wall section can be used to reproduce a sound field for a current (live) event, such as a football game at a particular location in a stadium. The sound field can be combined with video to provide a compelling experience for the person 112.

As indicated above, the wall section can be used in combination with video (or other media). For instance, a projector can be configured to project images on the surface 102 of the wall section, wherein the images are synchronized with audio emitted by the speakers of the wall section. In another example, the wall section can be used in connection with video in a full telepresence system, to display more information about audio rendering, a history of recent audio events, a user interface (UI) to control the wall 102, etc. In a video teleconferencing application, it may be natural to use the wall section to simulate the precise sound field of a remote scene. For instance, speech of a remote speaker can be accurately rendered so it seems to be coming from the mouth of the speaker as the speaker is rendered in view on the surface 102 of the wall section.

In another exemplary application, the wall section can be used in connection with non-realistic audio rendering. For instance, the wall section can be programmed to produce abstract audio signals, wherein the abstract audio signals lend themselves to unobtrusive peripheral monitoring. Rather than replicate a sound field, the processing electronics 110 of the wall section can be programmed to generate abstract audio events that indicate events relative to the person 112 (e.g., stock market movements or current events). The abstract audio events can be rendered in such a fashion that they seem to be happening “next door.” For instance, an event can be made more understandable by mapping the events onto well-understood audio events such as sporting events, the noises of a particular machine, a maritime environment, or speech patterns.

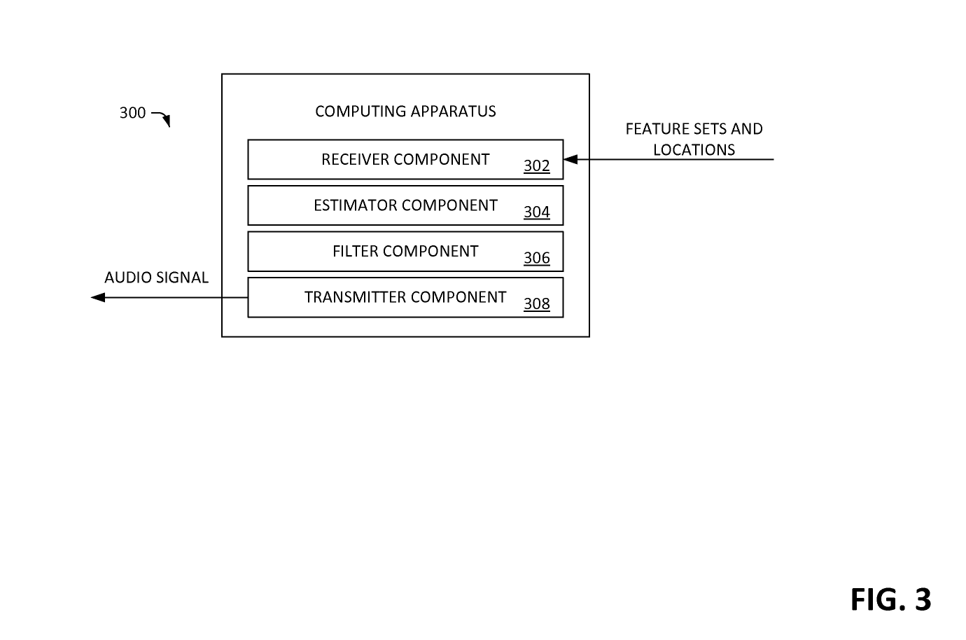

Now referring to FIG. 3, an exemplary computing apparatus 300 that can act as an intermediary between the construction element 100 and the wall section 202 when the construction element 100 and the wall section 202 are used in a telepresence application is illustrated. In another embodiment, the computing apparatus 300 can be used to process data received from the processing electronics 110 of the construction element 100 without communicating with the processing electronics of the wall section 202. For instance, the computing apparatus 300 may be included to perform processing as a cloud service. In an exemplary embodiment, the processing electronics 110 may be insufficient to compute the estimate of the sound field pertaining to the room 104. In such an embodiment, the processing electronics 110 can be configured to transmit the audio signals output by the microphones in the microphone array 108 to the computing apparatus 300. In another example, the processing electronics 110 can extract respective feature sets from the audio signals output by the microphones, and transmit such feature sets and locations of the microphones in the wall section (e.g., relative to one another) to the computing apparatus 300.

A receiver component 302 receives the feature sets and locations of the microphones. An estimator component 304 estimates a sound field in the room 104 based upon such feature sets and locations of the microphones. The estimator component 304 can, for instance, perform a plane wave decomposition in connection with estimating the sound field. The computing apparatus 300 optionally includes a filter component 306 that can filter audio as described above, such as amplifying energies at certain frequencies, adding audio, etc. A transmitter component 308 transmits a (compressed) audio signal that can include a plurality of audio signals for respective speakers (e.g., in the speaker array 106). While the components 302-308 have been described as being included in the computing apparatus 300, it is to be understood that one or more of the components 302-308 may be included in the processing electronics 110.

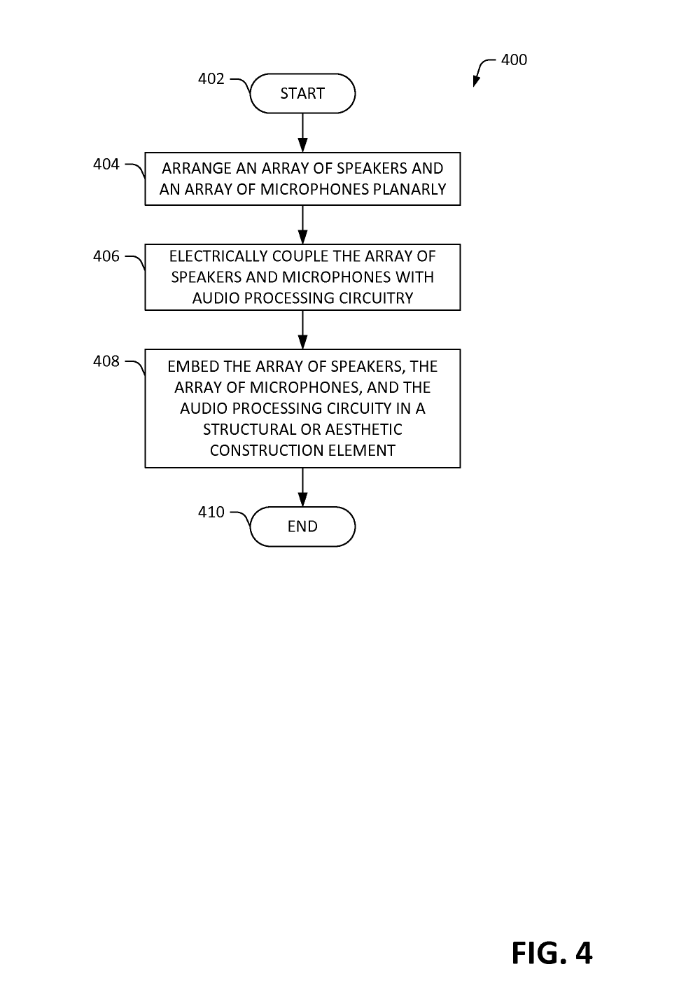

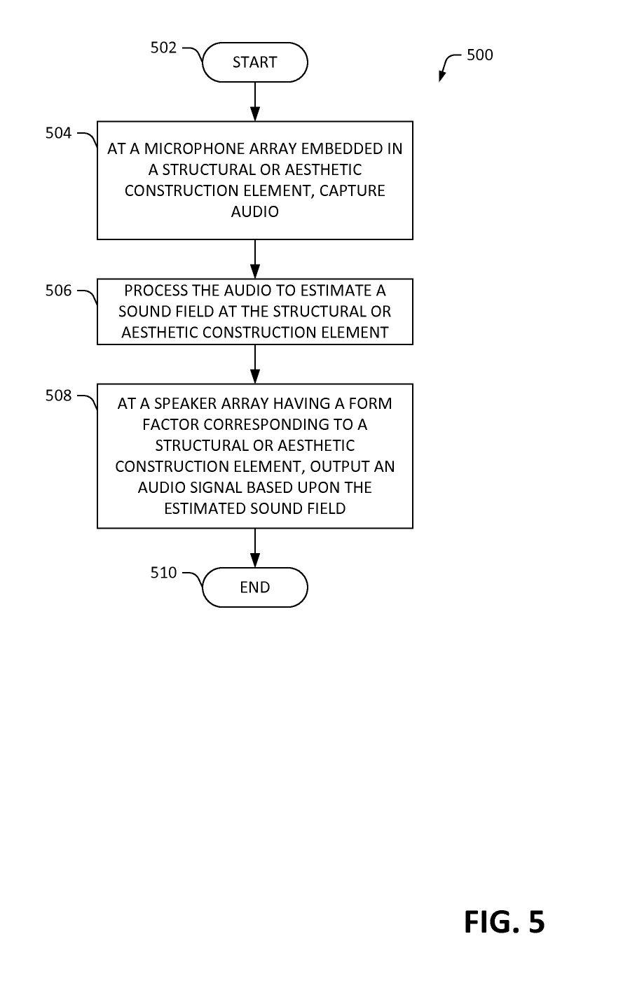

FIGS. 4-5 illustrate exemplary methodologies relating to construction and utilization of a structural or aesthetic building material having a speaker array, a microphone array, and processing electronics embedded therein. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Referring now to FIG. 4, an exemplary methodology 400 for constructing what can be referred to as a “mediating” structure is illustrated. The methodology 400 starts at 402, and at 404 an array of speakers and an array of microphones are arranged for placement in a structural or aesthetic construction element. For instance, the array of speakers and the array of microphones can be arranged in a planar fashion. In a still more specific example, the array of speakers and the array of microphones can be coplanar and placed on a backing.

At 406, the array of speakers and the array of microphones are electrically coupled to the audio processing circuitry. At 408, the array of speakers, the array of microphones, and the audio processing circuitry are embedded in a structural or aesthetic construction element, such as wall, baseboard, door, window frame, stairway element, fireplace element, column, beam, etc. In other embodiments, as noted above, the arrays and circuitry can be embedded in cabinetry, furniture (e.g., conference room tables), etc. The methodology 400 completes at 410.

Now referring to FIG. 5, an exemplary methodology 500 that facilitates generating audio based upon an estimated sound field corresponding to a room is illustrated. The methodology 500 starts at 502, and at 504 audio is captured by a microphone array embedded in a structural or aesthetic construction element. At 506, the audio is processed to estimate a sound field proximate to the structural or aesthetic construction element. At 508, an audio signal is output by a speaker array embedded in a structural or aesthetic construction element based upon the estimate of the sound field. For instance, the speaker array can reproduce the sound field. In another example, the speaker array can output cancellation signals that are configured to cancel reverberations.

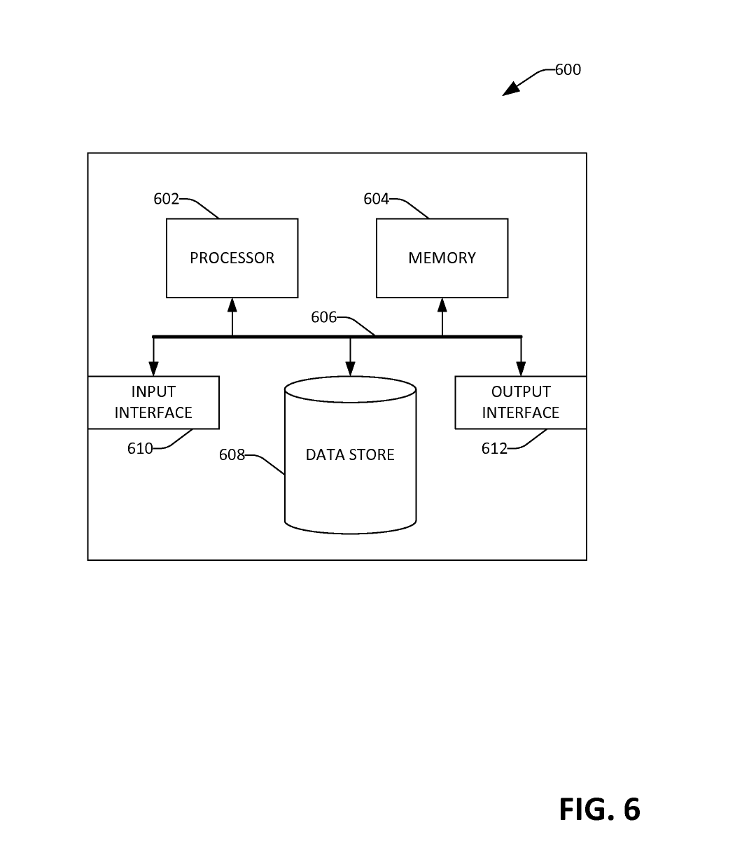

Referring now to FIG. 6, a high-level illustration of an exemplary computing device 600 that can be used in accordance with the systems and methodologies disclosed herein is illustrated. For instance, the computing device 600 may be used in a system that can estimate a sound field. By way of another example, the computing device 600 can be used in a system that outputs audio based upon an estimate of a sound field. The computing device 600 includes at least one processor 602 that executes instructions that are stored in a memory 604. The instructions may be, for instance, instructions for implementing functionality described as being carried out by one or more components discussed above or instructions for implementing one or more of the methods described above. The processor 602 may access the memory 604 by way of a system bus 606. In addition to storing executable instructions, the memory 604 may also store audio, filter values, etc.

The computing device 600 additionally includes a data store 608 that is accessible by the processor 602 by way of the system bus 606. The data store 608 may include executable instructions, video, etc. The computing device 600 also includes an input interface 610 that allows external devices to communicate with the computing device 600. For instance, the input interface 610 may be used to receive instructions from an external computer device, from a user, etc. The computing device 600 also includes an output interface 612 that interfaces the computing device 600 with one or more external devices. For example, the computing device 600 may display text, images, etc. by way of the output interface 612.

It is contemplated that the external devices that communicate with the computing device 600 via the input interface 610 and the output interface 612 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 600 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 600 may be a distributed system. Thus, for instance, several devices may be in communication by way of a network connection and may collectively perform tasks described as being performed by the computing device 600.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A structural or aesthetic construction element, comprising:
a frame; and
a surface affixed to the frame, the surface formed to facilitate transmission of audio therethrough, the surface and the frame forming an interior region, the interior region of the structural or aesthetic construction element comprising:
an array of speakers;
an array of microphones; and
processing electronics that drive the speakers and the microphones.

2. The structural or aesthetic construction element of claim 1 being a structural construction element, the structural construction element being one of a wall, a door, or a ceiling.

3. The structural or aesthetic construction element of claim 1 being an aesthetic construction element, the aesthetic construction element being one of a baseboard, crown molding, chair rail, or trim.

4. The structural or aesthetic construction element of claim 1, the surface having an interior surface that forms the interior region of the structural or aesthetic construction element, the array of speakers being a planar array of speakers, the array of microphones being a planar array of microphones, the array of speakers and the array of microphones positioned flush with the interior surface of the surface.

5. The structural or aesthetic construction element of claim 1, the array of speakers comprising at least three speakers, the array of microphones comprising at least three microphones.

6. The structural or aesthetic construction element of claim 1, the processing electronics configured to drive speakers in the array of speakers to reproduce a sound field.

7. The structural or aesthetic construction element of claim 1, the processing electronics configured to:
receive audio signals output by respective microphones in the array of microphones;
extract respective feature sets that are representative of the audio signals output by the respective microphones; and
transmit the respective features sets to remotely situated processing electronics by way of a network connection.

8. The structural or aesthetic construction element of claim 1, the processing electronics configured to:
receive data that is representative of a sound field of a volume that is remote from the structural construction element; and
transmit signals to respective speakers in the array of speakers that cause the array of speakers to recreate the sound field of the volume.

9. The structural or aesthetic construction element of claim 1, the processing electronics configured to:
receive audio signals output by respective microphones in the array of microphones, the audio signals received in a window of time;
generate a data structure, the data structure representative of an estimated sound field of a volume that is at least partially enclosed by the structural or aesthetic construction element for the window of time; and
responsive to receipt of a command, transmitting signals to respective speakers in the speaker array based upon the data structure, the signals causing the respective speakers in the speaker array to reproduce the sound field of the volume.

10. The structural or aesthetic construction element of claim 1, wherein the frame is formed of drywall.

11. The structural or aesthetic construction element of claim 1, further comprising an interface that is configured to receive electrical power from an external power source for powering the array of speakers, the array of microphones, and the processing electronics.

12. A wall section comprising:
a frame that defines boundaries of the wall section;
a surface that is affixed to the frame, the surface and the frame forming a cavity, the cavity of the wall section comprising:
an array of speakers;
an array of microphones; and
processing electronics that is configured to drive the array of speakers and the array of microphones.

13. The wall section of claim 12, the surface being between 1 millimeter and 5 millimeters in thickness, the surface being formed of paintable material.

14. The wall section of claim 12, further comprising electrical connectors positioned on a side thereof, the electrical connectors electrically coupled to the array of speakers, the array of microphones, and the processing electronics, the electrical connectors configured to mate with second electrical connectors of a second wall section.

15. The wall section of claim 12, wherein the array of speakers and the array of microphones are coplanar.

16. The wall section of claim 12, wherein the processing electronics are configured to transmit signals to respective speakers in the array of speakers to reproduce a sound field of a remote volume of space.

17. The wall section of claim 12, wherein the processing electronics are configured to:
receive signals output by respective microphones in the microphone array;
extract respective feature sets from the signals output by the respective microphones; and
transmit the respective features sets to a computing device that is external to the wall section.

18. The wall section of claim 12, wherein the surface is formed of a material that facilitates transmission of audio signals therethrough.

19. The wall section of claim 12, wherein the processing electronics are configured to:
receive a data packet from a computing device by way of a network connection, the computing device being external to the wall section, the data packet being representative of a sound field of a volume of a remote location; and
transmitting signals to respective speakers in the speaker array based upon the data packet, the signals causing the respective speakers in the speaker array to reproduce the sound field.

20. A wall section, comprising:
a frame that defines boundaries of the wall section;
a planar surface that is affixed to the frame, the planar surface formed of a material that facilitates transmission of acoustic waves therethrough, the planar surface and the frame forming a cavity, the cavity of the wall section comprising:
a plurality of co-planar speakers that are positioned to emit audio through the planar surface;
a plurality of co-planar microphones that are positioned to capture audio through the planar surface;
processing electronics that are configured to receive audio signals output by the plurality of co-planar microphones and transmit signals that cause the plurality of co-planar speakers to emit the audio.
